(19) United States
(12) Patent Application Publication
(10) Pub. No.: US 2026/0048559 A1
(43) Pub. Date: Feb. 19, 2026

(54) OPTICAL FIBER LAYING UNIT

(71) Applicant: Optec Technology Limited, Causeway Bay (HK)

(72) Inventors: Chung Yin AU, Causeway Bay (HK); Zirui WEI, Causeway Bay (HK); Yi CAO, Causeway Bay (HK); Huahan ZHAI, Causeway Bay (HK)

(21) Appl. No.: 18/936,454

(22) Filed: Nov. 4, 2024

(30) Foreign Application Priority Data
Aug. 15, 2024 (HK) 32024095577.5

(51) Int. Cl. B29C 70/38; B29C 70/54

(52) U.S. Cl. CPC B29C 70/384; B29C 70/541

(57) ABSTRACT

An optical fiber laying unit (108, 208, 308, 408) is disclosed as including a support (106) for supporting a substrate, and a working head (110, 210, 310, 410) movable relative to the support along a first path parallel to an X-axis, along a second path parallel to a Y-axis which is perpendicular to the X-axis, and along a third path parallel to a Z-axis which is perpendicular to the X-axis and the Y-axis, the working head being engageable with a piece of optical fiber (128) and is movable along at least one of the first path, the second path and the third path to lay at least part of the piece of optical fiber on a substrate supported by the support.

### FIELD OF THE INVENTION

This invention relates to an optical fiber laying unit and an optical fiber handling machine including such a unit.

### BACKGROUND OF THE INVENTION

Optical fibers are now in widespread use in particular in long-distance data communication Optical fibers are engaged with various kinds of connectors for fixed or releasable engagement with different kinds of communication and or data processing apparatus such as computers servers etc Thus far human workers have to be involved at least in part in handling optical fibers such as laying optical fibers on a substrate Because of this not only will the handling cost be increased but also consistency of quality cannot be ensured.

It is thus an object of the present invention to provide an optical fiber laying unit and an optical fiber handling machine in which at least one of the aforesaid shortcomings is mitigated or at least to provide a useful alternative to the trade and public.

### SUMMARY OF THE INVENTION

According to a first aspect of the present invention, there is provided an optical fiber laying unit including a support for supporting at least one substrate; and a working head movable relative to said support along a first path parallel to a first axis, along a second path parallel to a second axis which is substantially perpendicular to said first axis, and along a third path parallel to a third axis which is substantially perpendicular to said first axis and said second axis; wherein said working head is engageable with a piece of optical fiber and is movable along at least one of said first path, said second path and said third path to lay at least a part of said piece of optical fiber on a substrate supported by said support.

According to a second aspect of the present invention, there is provided an optical fiber handling machine including at least an optical fiber laying unit, said optical fiber laying unit including a support for supporting at least one substrate; and a working head movable relative to said support along a first path parallel to a first axis, along a second path parallel to a second axis which is substantially perpendicular to said first axis, and along a third path parallel to a third axis which is substantially perpendicular to said first axis and said second axis; wherein said working head is engageable with a piece of optical fiber and is movable along at least one of said first path, said second path and said third path to lay at least a part of said piece of optical fiber on a substrate supported by said support.

### BRIEF DESCRIPTION OF THE DRAWINGS

Optical fiber laying units and optical fiber handling machines including an optical fiber laying unit according to embodiments of the present invention will now be described, by way of examples only, with reference to the accompanying drawings, in which:

FIG. 1 is a perspective view of an automatic optical fiber handling machine according to a first embodiment of the present invention;

FIG. 2 is a front view of the automatic optical fiber handling machine of FIG. 1;

FIGS. 3 to 12 show operation of the automatic optical fiber handling machine of FIG. 1; in particular,

FIG. 3 shows that, after a previous sequence of operation, the working head is above the support;

FIG. 4 shows the holder then moving along the rail parallel to the X-axis until the working head is above a clamp;

FIG. 5 shows downward movement of the working head towards the clamp;

FIG. 6 shows that after the working head reaches a predefined position above the clamp, the piece of optical fiber is driven to extend further away from the tunnel until at least a part of the piece of optical fiber is between the flat surfaces of the jaws of the clamp;

FIG. 7 shows the jaws then being driven to move towards each other to secure and hold the piece of optical fiber between the pair of flat surfaces of the jaws of the clamp;

FIG. 8 shows that after securing an end of the piece of optical fiber by the clamp, the holder travels along the rail away from the clamp and towards the support;

FIG. 9 shows that when the working head 110 reaches a predetermined position above the support, the holder is driven downward until the piece of optical fiber touches a part of the substrate, for subsequently laying the piece of optical fiber on the substrate;

FIG. 10 shows movement of the working head along a path to lay more of the piece of the optical fiber on the support;

FIG. 11 shows that after moving a predetermined distance along the path and thus laying a first segment of the piece of optical fiber, the working head swivels by around ninety degrees in the counter-clockwise direction when viewed from above;

FIG. 12 shows the holder carried by the rail which is then moved in a path to lay on the support a second segment of the piece of optical fiber, which is perpendicular to the first segment of the piece of optical fiber;

FIG. 13 shows a part of an automatic optical fiber laying unit according to a second embodiment of the present invention;

FIG. 14 shows a part of an automatic optical fiber laying unit according to a third embodiment of the present invention; and

FIG. 15 shows a part of an automatic optical fiber laying unit according to a fourth embodiment of the present invention.

### DESCRIPTION OF THE EMBODIMENTS

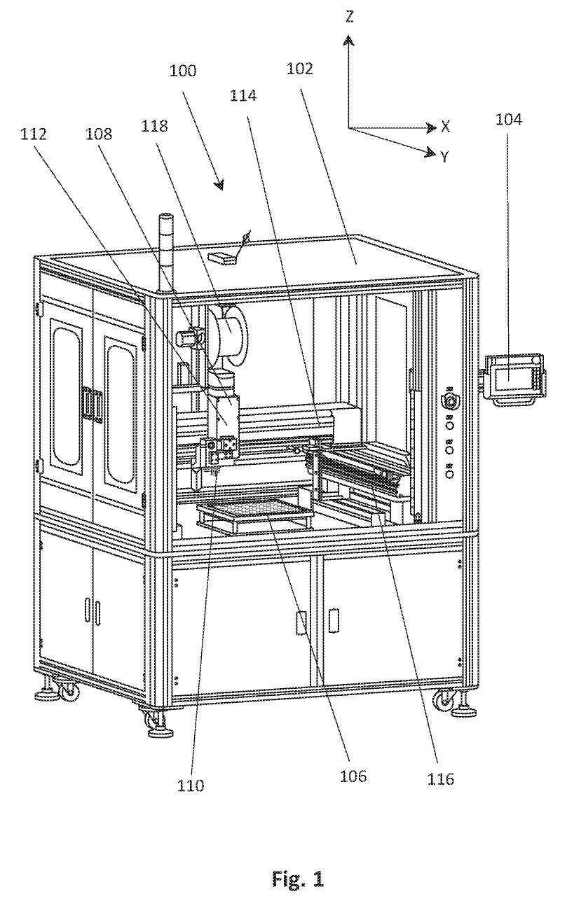

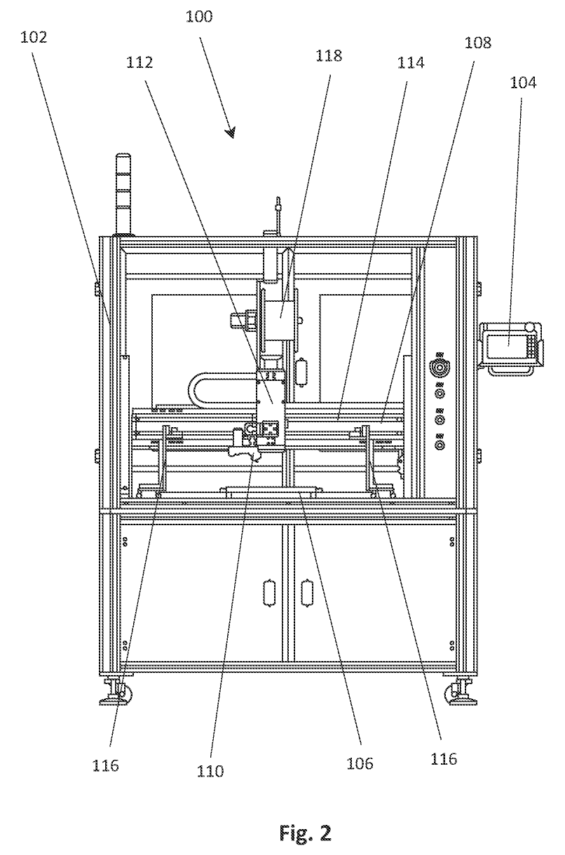

An automatic optical fiber handling machine according to a first embodiment of the present invention is shown in FIGS. 1 and 2, and generally designated as 100. The machine 100 is under computer numerical control (CNC), to increase efficiency, lower the processing cost, and ensure consistency of the final products. The machine 100 has a body 102 mounted with a control panel 104, which provides an interface allowing input of instructions to the machine 100 and display of status of operation of the machine 100. The machine 100 further includes a support 106 for supporting one or more substrates (not shown) to be processed by the machine 100.

The machine 100 includes an optical fiber laying unit 108 for laying a length of optical fiber on one or more substrates on the support 106. The unit 108 includes a working head 110 (which may be in the form of a rotatable roller) carried by a holder 112 for simultaneous movement. The holder 112 is mounted on a rail 114 (which is parallel to an X-axis (as shown in FIG. 1)) and may be driven by one or more cylinders (e.g., serve motor/electrical cylinders) (not shown) to move to-and-fro along the rail 114, and relative to the support 106.

The rail 114 is mounted to and movable relative to two parallel side rails 116 which are parallel to a Y-axis (as shown in FIG. 1), which is perpendicular to the X-axis. The rail 114 may be driven by one or more cylinders (e.g., serve motor/electrical cylinders) (not shown) for to-and-fro movement along the side rails 116, thus bringing about corresponding simultaneous to-and-fro movement of the holder 112 (and thus of the working head or roller 110) along a path parallel to the Y-axis.

The holder 112 (with which the working head 110 is attached for simultaneous movement) may also be driven by one or more cylinders (e.g., serve motor/electrical cylinders) (not shown) to move to-and-fro, relative to the support 106, and along a path which is parallel to a Z-axis (as shown in FIG. 1), which is perpendicular to both the X-axis and the Y-axis. In addition, the working head 110 may also be driven to swivel relative to the holder 112 about an axis parallel to the Z-axis.

While at any one time, the working head 110 may only move along a first path parallel to the X-axis, or move along a second path parallel to the Y-axis, or move along a third path parallel to the Z-axis, or swivel about an axis parallel to the Z-axis, it is envisaged that, two or more (or even up to all four) such movements may occur simultaneously, so to increase the speed of operation.

The machine 100 further includes a rotatable spool 118 for storing a piece of optical fiber (such as by winding the piece of optical fiber around the spool 118) for subsequent operation. The piece of optical fiber may be moved by a driver to extend away from the spool 118 towards the working head 110, thus causing the spool 118 to rotate about its own axis of rotation.

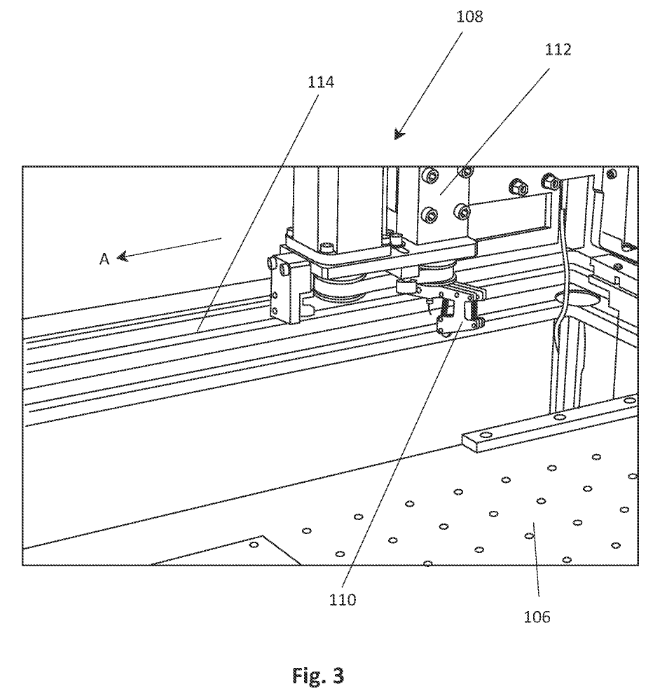

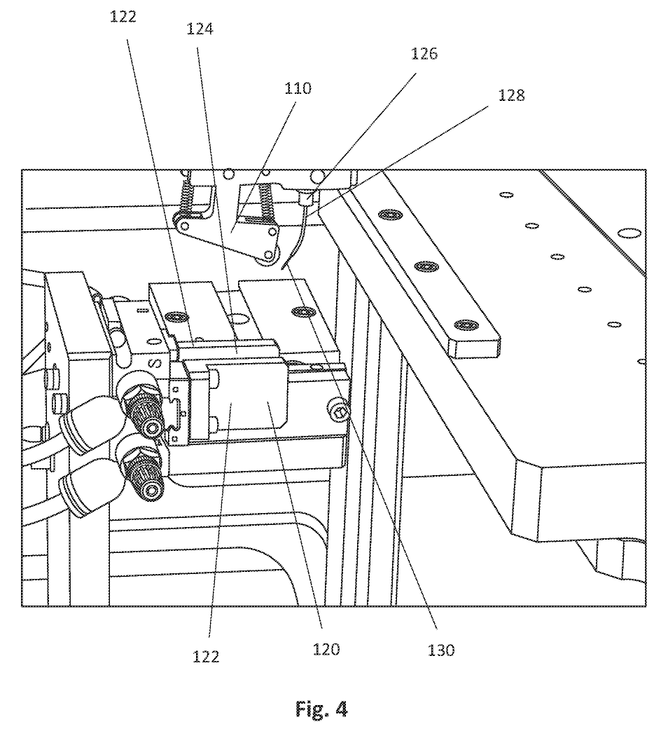

Close-up views of an exemplary sequence of operation of the optical fiber laying unit 108 of the optical fiber handling machine 100 are shown in FIGS. 3 to 12. FIG. 3 shows that, after a previous sequence of operation, the working head 110 is above the support 106. The holder 112 then moves along the rail 114 in the direction A (which is parallel to the X-axis) until the working head 110 is above a clamp 120, as shown in FIG. 4. The clamp 120 has a pair of jaws 122 with a pair of oppositely-facing flat surfaces 124. The jaws 122 may be driven by one or more cylinders (e.g., serve motor/electrical cylinders) to move towards each other (so that the two flat surfaces 124 come into contact with each other) or away from each other (so that the two flat surfaces 124 are out of contact with each other).

The working head 110 further includes a tunnel 126 through which the piece of optical fiber 128 extends, so that the piece of optical fiber 128 is movable through the tunnel 126 in the length-wise direction, with the tunnel 126 guiding such length-wise movement of the optical fiber 128 relative to the working head 110. It can be seen in FIG. 4 that a free end 130 of the optical fiber 128 extends out from the tunnel 126.

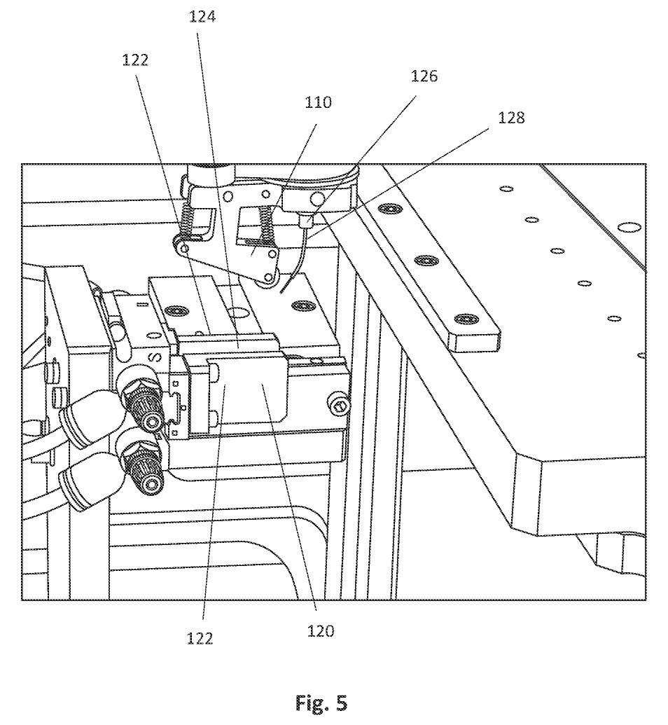

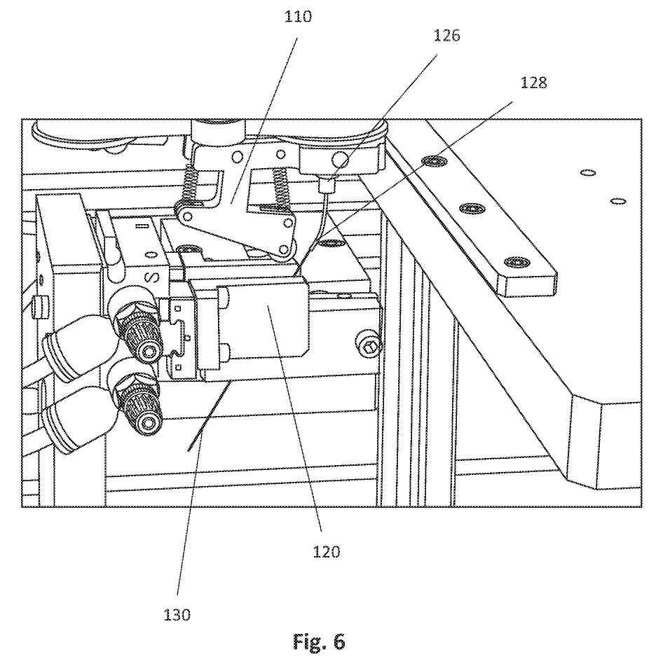

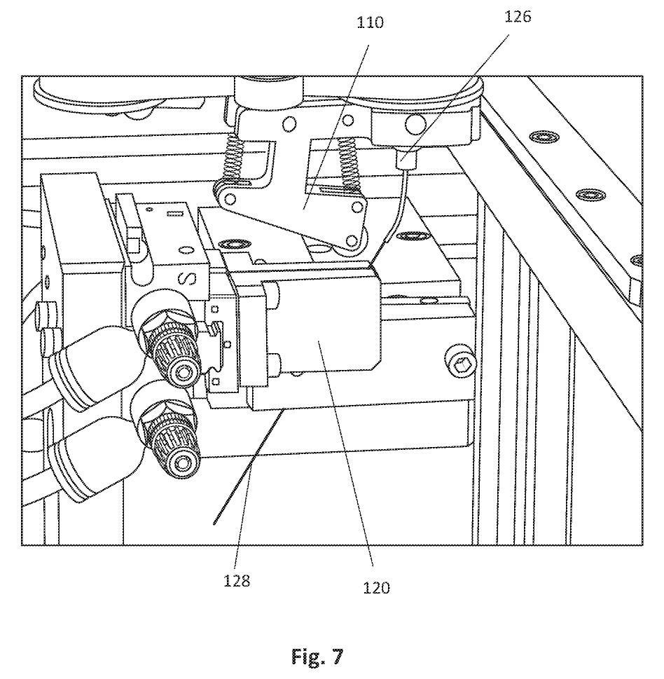

FIG. 5 shows downward movement of the working head 110 (which is parallel to the Z-axis) towards the clamp 120. As shown in FIG. 6, after the working head 110 reaches a predefined position above the clamp 120, the piece of optical fiber 128 is driven to extend further away from the tunnel 126 until at least a part of the piece of optical fiber 128 is between the flat surfaces 124 of the jaws 122 of the clamp 120 (which is in a jaw-open configuration). The jaws 122 are then driven (e.g., by one or more serve motor/electrical cylinders) to move towards each other to secure and hold the piece of optical fiber 128 between the pair of flat surfaces 124 of the jaws 122 of the clamp 120 (which is in a jaw-closed configuration), as shown in FIG. 7. It can be seen that, when the clamp 120 is in the jaw-open configuration, the piece of optical fiber 128 may be disengaged from the clamp 120, and when the clamp 120 is in the jaw-closed configuration, the piece of optical fiber 128 held by the clamp 120 cannot be disengaged from the clamp 120.

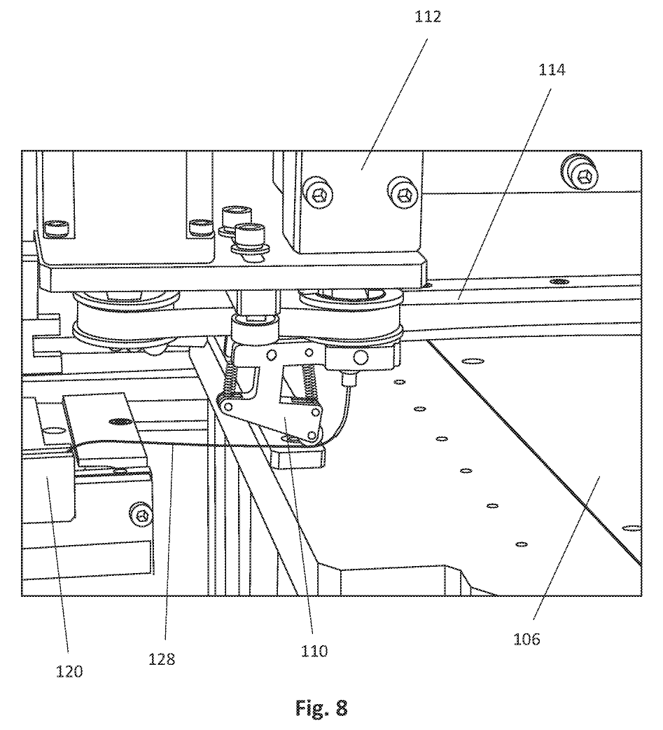

After securing an end of the piece of optical fiber 128 by the clamp 120, and as shown in FIG. 8, the holder 112 (simultaneously with the working head 110 carried by it) travels along the rail 114 in a direction opposite to A in FIG. 3, away from the clamp 120, and towards the support 106. In so doing, more of the piece of optical fiber 128 is drawn out from the spool 118 (see FIGS. 1 and 2) such that the length of the piece of optical fiber 128 between the clamp 120 and the working head 110 increases correspondingly.

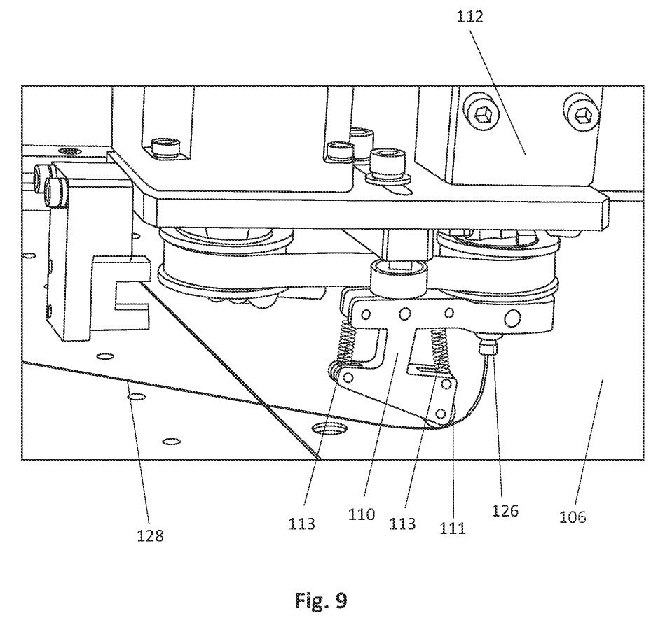

When the working head 110 reaches a predetermined position above the support 106, and as shown in FIG. 9, the holder 112 is driven downward (in a direction parallel to the Z-axis) until the piece of optical fiber 128 touches a part of the substrate (not shown), for subsequently laying the piece of optical fiber 128 on the substrate. As no substrate is now placed on the support 106, the support 106 is treated as the substrate for illustration purposes. It can be seen that the working head 110 a rotatable roller 111, which applies and guides the piece of optical fiber 128 on the substrate. The working head 110 also has two balancing springs 113 which provide automatic mechanical balancing to the working head 110 and a vertical spring which provides damping of the working head 110 on the piece of optical fiber 128.

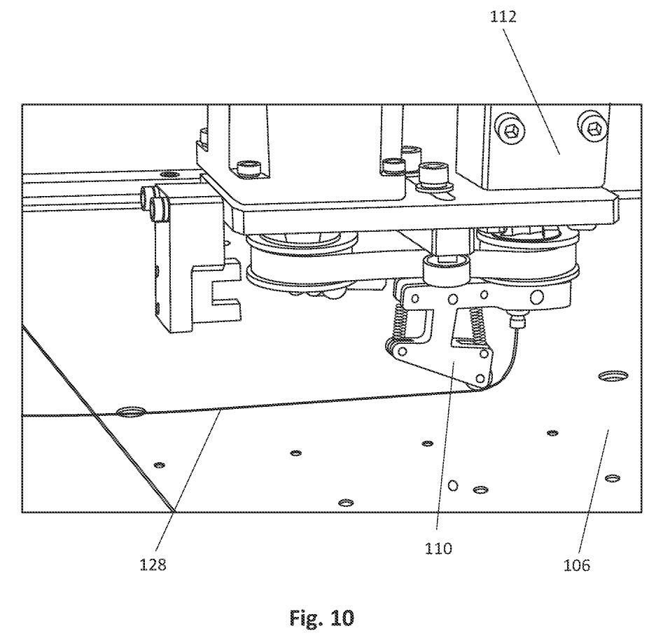

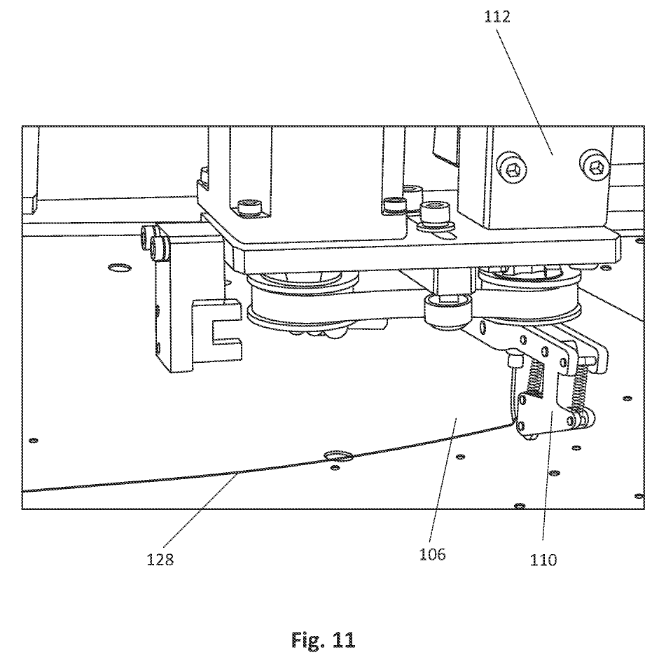

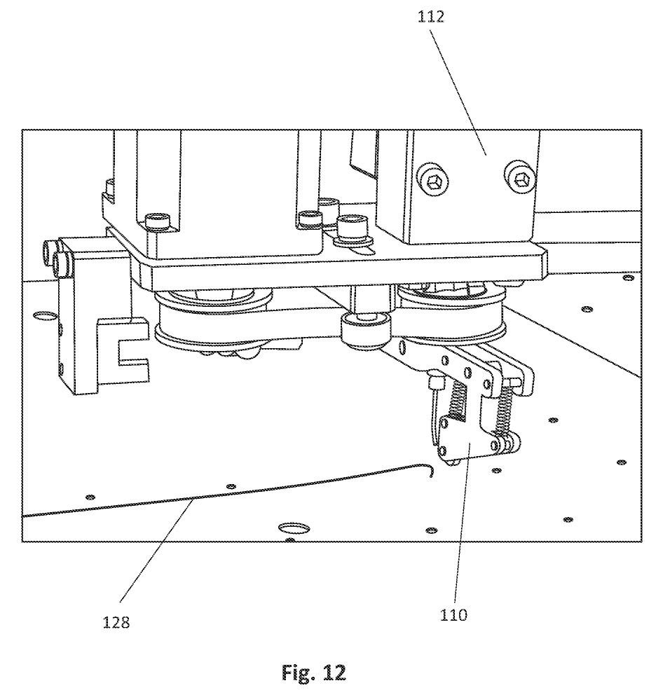

FIG. 10 shows movement of the working head 110 along a path parallel to the X-axis, to lay more of the piece of the optical fiber 128 on the support 106. During such movement, the working head 110 rides on and along the piece of optical fiber 128 drawn out of the spool 118, to guide and lay the optical fiber 128 on the substrate. After moving a predetermined distance along the path parallel to the X-axis, and thus laying a first segment of the piece of optical fiber 128 of a predetermined length along a path parallel to the X-axis on the support 106, and as shown in FIG. 11, the working head 110 swivels by around 90^{o} in the counter-clockwise direction (when viewed from above), about an axis parallel to the Z-axis. As shown in FIG. 12, the holder 112 (and with the working head 110 carried by it) carried by the rail 114 is then moved in a path parallel to the Y-axis (as shown in FIG. 1), to lay on the support 106 a second segment of the piece of optical fiber 128, which is perpendicular to the first segment of the piece of optical fiber 128.

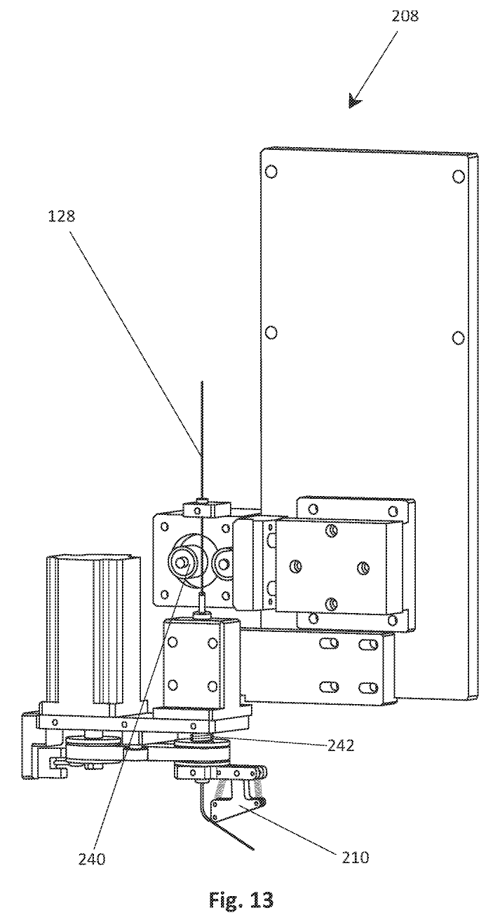

FIG. 13 shows a schematic view of part of an optical fiber laying unit, generally designated as 208, according to another embodiment of the present invention. This laying unit 208 includes a roller 240 which assists in guiding movement of the piece of optical fiber 128 from the spool 118 (not shown) to a working head 210. A spring 242 with its longitudinal axis vertically oriented is provided above the working head 210 to provide damping of the working head 210 on the piece of optical fiber 128.

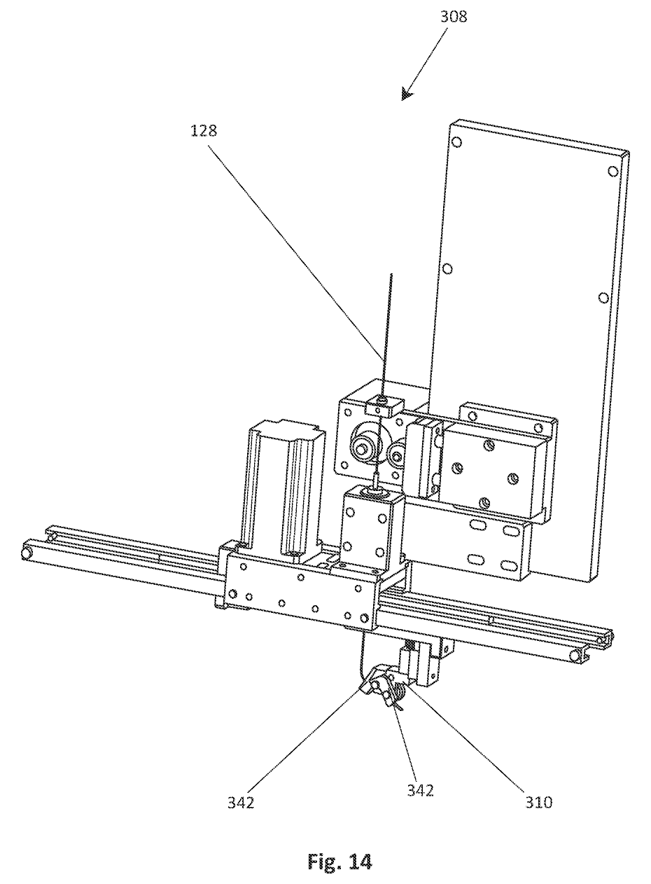

FIG. 14 shows a schematic view of part of an optical fiber laying unit, generally designated as 308, according to a further embodiment of the present invention. A working head 310 of this laying unit 308 includes two finger members 342, for controlling movement of the piece of optical fiber 128.

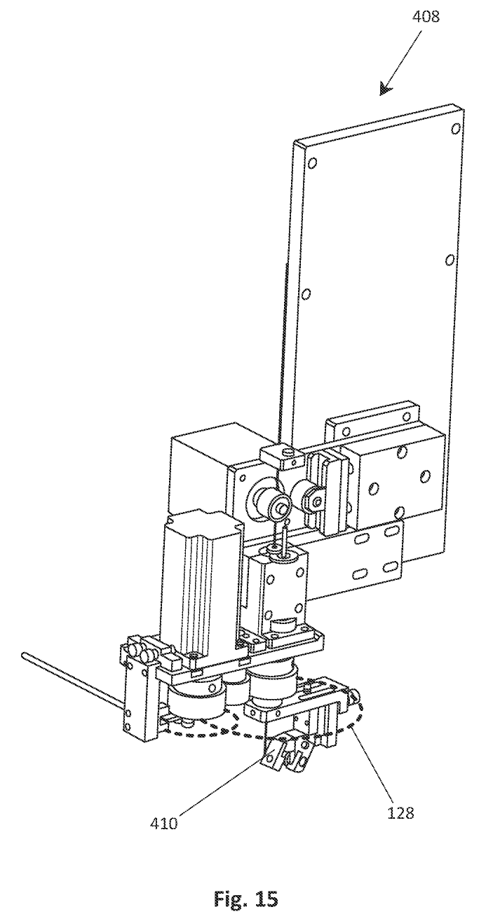

FIG. 15 shows a schematic view of part of an optical fiber laying unit, generally designated as 408, according to yet another embodiment of the present invention. It can be seen that the piece of optical fiber 128 is arranged to go through a different path before being engaged with a working head 410.

While the machine 100 is shown and discussed above as including only one optical fiber laying unit 108, 208, 308, 408, it should be understood that, firstly, the machine 100 can include a plurality of optical fiber laying units for working on a plurality of substrates on the support 106. Secondly, the machine 100 can include other processing units for carrying out other kinds of processes or operations on the substrate(s) and/or optical fiber 128, so that more steps for handling, treating and/or processing the substrate(s) and/or optical fiber 128 can be automated, and handled by a single machine 100.

The machine 100 can provide auto-mechanical balancing and/or damping features on the optical fiber 128 through the working head or roller 110, and can operate on optical fibers of different sizes. In addition, as the machine 100 is under computer numerical control (CNC), high precision (e.g., in terms of the length of linear movement along each of the X-axis, Y-axis, Z-axis, and degree of rotational movement about the Z-axis) can be attained.

It should be understood that the above only illustrates examples whereby the present invention may be carried out, and that various modifications and/or alterations may be made thereto without departing from the spirit of the invention. It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

Claims:

1. An optical fiber laying unit including:
a support for supporting at least one substrate; and
a working head movable relative to said support along a first path parallel to a first axis, along a second path parallel to a second axis which is substantially perpendicular to said first axis, and along a third path parallel to a third axis which is substantially perpendicular to said first axis and said second axis;
wherein said working head is engageable with a piece of optical fiber and is movable along at least one of said first path, said second path and said third path to lay at least a part of said piece of optical fiber on a substrate supported by said support.

2. The unit according to claim 1, wherein said working head is swivellable about an axis substantially parallel to said third axis.

3. The unit according to claim 1, further including a storing member for storing at least part said piece of optical fiber.

4. The unit according to claim 3, further including a driver for moving said piece of optical fiber away from said storing member to said working head.

5. The unit according to claim 1, further including a clamp for releasably holding said piece of optical fiber.

6. The unit according to claim 5, wherein said clamp is movable between a closed configuration preventing disengagement of said piece of optical fiber from said clamp and an open configuration allowing disengagement of said piece of optical fiber from said clamp.

7. The unit according to claim 6, wherein said clamp includes two jaw members which are movable towards or away from each other by at least one serve motor/electrical cylinder to thereby move said clamp between said closed configuration and said open configuration.

8. The unit according to claims claim 5, wherein when a free end of said piece of optical fiber is held by said clamp, said working head is movable away from said clamp to draw out said piece of optical fiber from said storing member.

9. The unit according to claim 8, wherein when said free end of said piece of optical fiber is held by said clamp, said working head is movable away from said clamp and along said piece of optical fiber to increase the length of said piece of optical fiber between said clamp and said working head.

10. The unit according to claim 1, wherein said working head includes a tunnel through which said piece of optical fiber is extensible for relative movement in the length-wise direction.

11. The unit according to claim 1, wherein said working head includes a roller.

12. The unit according to claim 11, wherein said roller is adapted to apply and guide movement of said piece of optical fiber on said substrate.

13. The unit according to claim 1, wherein said working head includes two springs for providing automatic mechanical balancing to said working head.

14. The unit according to claim 1, wherein said working head includes a substantially vertical spring for providing damping of said working head on said piece of optical fiber.

15. An optical fiber handling machine including at least an optical fiber laying unit according to claim 1.
